(19) United States
(12) Patent Application Publication
(10) Pub. No.: US 2002/0157448 A1
(43) Pub. Date: Oct. 31, 2002

(54) Flowmeter calibration apparatus

(76) Inventors: Katahisa Hirai, Tokyo (JP); Masao Hayakawa, Tokyo (JP); Takeshi Yakuwa, Tokyo (JP); Akira Hirai, Tokyo (JP)

Correspondence Address: BURNS DOANE SWECKER & MATHIS L L P, POST OFFICE BOX 1404, ALEXANDRIA, VA, 22313-1404, US

(21) Appl. No.: 09/757,467

(22) Filed: Jan. 11, 2001

(30) Foreign Application Priority Data
Sep. 5, 2000 (JP) P-2000-267881

(51) Int. Cl. G01P 21/00; G01F 25/00

(52) U.S. Cl. 73/1.16; 73/861.18

(57) ABSTRACT

A heat type mass flowmeter calibration apparatus includes standard heat type mass flowmeters and sonic nozzle type mass flowmeters connected in series. Periodically or when required, the national-standard-traceable sonic nozzle type mass flowmeter that is traceable with respect to a national standard is used to calibrate the standard heat type mass flowmeters. Actual flowmeter measurements are conducted using the calibrated standard heat type mass flowmeter values. Therefore, consistently high precision of calibrations and measurements is guaranteed.

### BACKGROUND OF THE INVENTION

1. Field of the Invention

This invention relates to a flowmeter calibration apparatus that is able to traceably calibrate to a national standard a heat type mass flowmeter used extensively to measure gas mass flows, and can measure a mass flowmeter or mass flow rate controller that is being tested using the calibrated heat type mass flowmeter.

2. Description of the Prior Art

Manufacturers and users of heat type mass flow rate controllers or heat type mass flowmeters normally use their own reference standard flowmeters to calibrate the controllers or flowmeters. These standard flowmeters are not traceable with reference to a national standard. In practice, a heat type mass flowmeter calibrated using the standard flowmeter is used as a working standard.

Heat type mass flowmeters are known to lack reliability, since the characteristics of the sensor section are subject to time-based changes in zero point and indicated values, and are highly dependent on variations in the ambient temperature and working pressure. This makes it difficult to precisely calibrate or measure a test mass flowmeter by using such a heat type mass flowmeter.

Moreover, taking full scale as 100%, a heat type mass flowmeter is usually calibrated at 0%, 50% and 100%, and guaranteed performance is expressed in terms of error relative to full scale. This means that even if a full scale performance precision of 1% is guaranteed, the reading of a flow rate that is 10% of fullscale will have an error tolerance of 10%. Consequently, in some cases it may not be possible to obtain a precise calibration or measurement.

For a mass flowmeter that is traceable with respect to a national standard, in U.S. Pat. No. 6,012,474, the present inventors proposed a mass flow rate controller with a sonic nozzle that guarantees the extended uncertainty of a reading. This sonic nozzle type mass flow rate controller enables a heat type mass flowmeter to be calibrated to a very high level of precision. The calibration can be performed by attaching the controller to the downstream side of the flowmeter being calibrated, and using a vacuum pump on the downstream side of the sonic nozzle to reduce the pressure to satisfy the nozzle critical condition.

This sonic nozzle type mass flow rate controller can be used to calibrate new heat type mass flowmeters. However, when there is a re-inspection of a heat type mass flowmeter used in semiconductor fabrication processes and the like, the heat type mass flowmeter is contaminated by the gas used, so with the sonic nozzle type mass flowmeter being connected on the downstream side, there is a risk that the nozzle will be contaminated, changing the characteristics. If the sonic nozzle characteristics change, high-precision calibration becomes impossible.

A main object of the present invention is therefore to provide a flowmeter calibration apparatus that can calibrate and measure a mass flowmeter with high precision, regardless of whether the flowmeter is new or not.

### SUMMARY OF THE INVENTION

In accordance with the present invention, the above and other objects are attained by a flowmeter calibration apparatus comprising: a reference standard heat type mass flowmeter that is used as a practical standard flowmeter for measurements of a test mass flowmeter; a sonic nozzle type mass flow rate controller connected in series on a downstream side of the standard heat type mass flowmeter; a connection port for effecting a series connection of the subject mass flowmeter on the downstream side of the standard heat type mass flowmeter; a vacuum pump for maintaining a prescribed ratio between upstream pressure and downstream pressure in the sonic nozzle type mass flow rate controller; and a control section that includes reference standard flowmeter calibration means that uses the sonic nozzle type mass flow rate controller to effect calibration of the standard heat type mass flowmeter, and a test mass flowmeter measurement means that, based on a result of said calibration, uses the standard heat type mass flowmeter to effect measurement of the test mass flowmeter connected to said connection port.

Typically, the flowmeter calibration apparatus of this invention comprises a gas delivery port, n (where n is a positive integer) reference standard heat type mass flowmeters having different measurement ranges connected in series with the gas delivery port, and sonic nozzle type mass flow rate controllers having corresponding measurement ranges connected on the downstream side of the standard heat type mass flowmeters.

In a preferred embodiment, the standard flowmeter calibration means comprises selection means for selecting a standard heat type mass flowmeter to be calibrated, setting means for setting parameters, including calibration gas, of a sonic nozzle type mass flow rate controller used to calibrate the selected standard heat type mass flowmeter, recording means for incrementally changing flow rate settings of said sonic nozzle type mass flow rate controller and recording output voltage of the standard heat type mass flowmeter being calibrated, and calibration formula generation means that assigns flow rate values to the recorded output voltages and generates a flow rate calibration formula for the standard heat type mass flowmeter.

With the flowmeter calibration apparatus of the invention thus configured, the sonic nozzle type mass flow rate controller can be used to calibrate the readings of the standard heat type mass flowmeter used as a working standard, each time the standard heat type mass flowmeter is used or at whatever time is convenient, and a calibration formula is generated (a curve of differences between flowmeters or an approximation formula thereof). Measurements on the actual test mass flowmeter are performed using a standard heat type mass flowmeter calibrated on the basis of the calibration formula. Thus, in accordance with the present invention, the standard heat type mass flowmeter used as the working standard can be constantly calibrated to within the degree of uncertainty of the sonic nozzle type mass flow rate controller, without having to take into consideration flowmeter variation factors such as changes over time, changes in ambient temperature, and working pressure dependency. As a result, measurement values obtained with the calibrated standard heat type mass flowmeter are traceable with respect to a national standard, and readings can be guaranteed. This ensures that measurements can always be carried out with high precision. Moreover, since the sonic nozzle type mass flow rate controller is not directly connected to the test flowmeter, there is no risk that the sonic nozzle characteristics will be altered.

Further features of the invention, its nature and various advantages will be more apparent from the accompanying drawings and following detailed description of the invention.

### BRIEF DESCRIPTION OF THE DRAWINGS

FIGS. 1(A) to 1(C) show front, side and plan views of a heat type mass flowmeter calibration apparatus according to the present invention, respectively.

FIG. 2 is a schematic diagram of the gas flow system used in the apparatus of FIG. 1.

FIG. 3 is a schematic diagram of the electrical system of the apparatus of FIG. 1.

FIG. 4 is a flow chart of the standard heat type mass flowmeter calibration operation in the apparatus of FIG. 1.

FIG. 5 is an explanatory diagram showing an example of a working screen during the calibration process.

### DESCRIPTION OF THE PREFERRED EMBODIMENT

An embodiment of the heat type mass flowmeter calibration apparatus according to the present invention will now be described with reference to the drawings. The heat type mass flowmeter calibration apparatus of this embodiment is a gas system that can measure the flow rate of a heat type mass flow rate controller (hereinafter abbreviated to “MFC”) with high precision, using a sonic nozzle type mass flow rate controller (hereinafter abbreviated to “SNC”) and a standard heat type mass flowmeter (hereinafter abbreviated to “Std. MFM”). The internal SNC is a national standard traceable mass flowmeter. The Std. MFM is calibrated using SNC values, and the Std. MFM is used to automatically measure a test MFC.

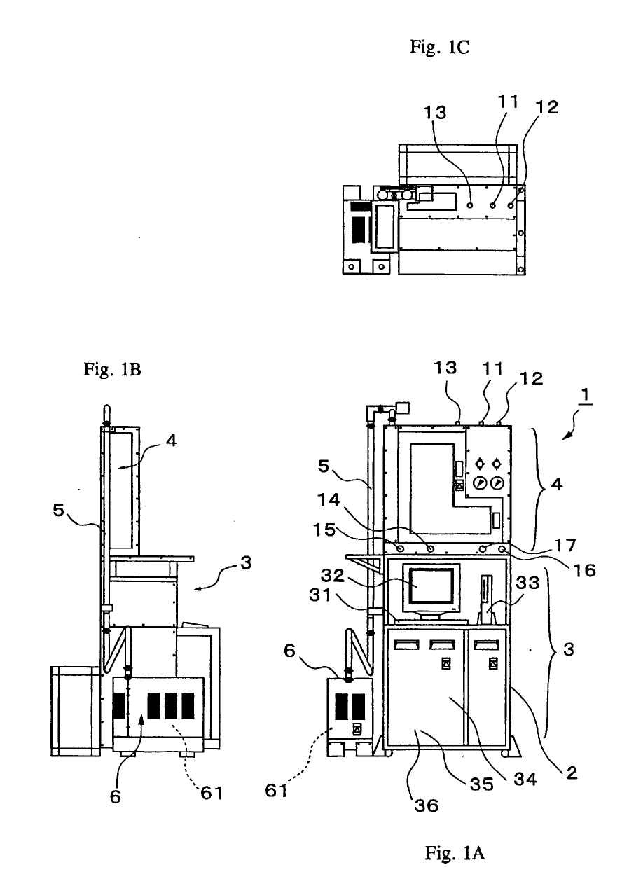

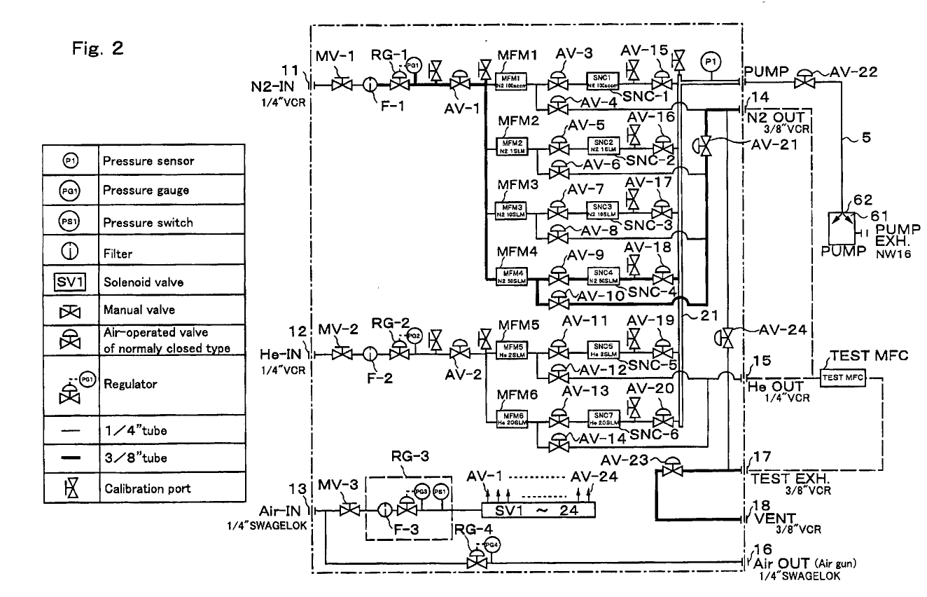

FIGS. 1(A), 1(B) and 1(C) respectively show front, side and plan views of the heat type mass flowmeter calibration apparatus 1 of this embodiment. As shown, the heat type mass flowmeter calibration apparatus 1 has an electrical section 3 attached to a frame 2, and a gas control section 4. The gas control section 4 is connected to an exhaust section 6 by an exhaust pipe 5. A display 32 and a keyboard 31 are connected to the electrical section 3, which includes a desktop PC 33 that handles data display tasks and input and control processing, a voltmeter 34, an SNC controller section 35 and a control unit 36. The gas control section 4 comprises SNCs 1 to 6, Std. MFMs 1 to 6, valves, connectors, and so forth (FIG. 2).

The exhaust section 6 includes a vacuum pump 61 that, when the SNC is used to calibrate the Std. MFM, is used to adjust the ratio between the pressures upstream and downstream of the nozzle to one that enables effective measurement. Located on the top of the gas control section 4 are a nitrogen gas inlet 11, helium gas inlet 12 and air inlet 13. On the front are located the gas outlets 14, 15 and 16, and connection port 17 on the downstream side of the test MFC. The upstream side of the test MFC is connected to gas outlets 14 and 15, and the downstream side to the connection port 17.

FIG. 2 is a schematic diagram of the gas flow system on the gas control section 4 used in the calibration apparatus 1. In this example, purified nitrogen and purified helium are used as calibration gases. The calibration flow rate of nitrogen gas is from 100 (SCCM) to 50 (SLM), and the calibration flow rate of helium gas is from 200 (SCCM) to 20 (SLM). Via manual valve MV-1, filter F1, regulator RG-1 and a normally-closed air-operated valve AV-1, the nitrogen gas inlet 11 is connected in parallel to standard MFM1, MFM2, MFM3 and MFM4. The ranges of MFM1 to MFM4 are 100 SCCM, 1 SLM, 10 SLM and 50 SLM.

The downstream side of the standard MFM1 is connected in series with SNC1, via valve AV-3, and the downstream side of the SNC1 is connected via valve AV-15 to a common exhaust pipe 21. The common exhaust pipe 21 is connected, via valve AV-22 and exhaust pipe 5, to suction port 62 of vacuum pump 61. The downstream side of the standard MFM1 is also connected, via valve AV-4, to the nitrogen gas outlet 14. Standard MFM2, 3 and 4 have the same downstream connection configuration, being connected to SNC2, 3 and 4 via valves AV-5, 7 and 9, and on the downstream side thereof are also connected to the common exhaust pipe 21 via valves AV-16, 17 and 18. The respective downstream sides of standard MFM2, 3 and 4 pass through valves AV-6, 8, 10, and then all three pass through a common valve AV-21 and are connected to the nitrogen gas outlet 14. The full-scale ranges of SNC1 through 4 are 100 SCCM, 1 SLM, 10 SLM and 50 SLM, respectively.

The helium gas inlet 12 is connected in parallel to standard MFM5 and standard MFM6, via manual valve MV-2, filter F2, regulator RG-2 and a normally-closed air-operated valve AV-2. The full-scale ranges of MFM5 and 6 are 2 SLM and 20 SLM. The downstream side of the standard MFM5 is connected in series with SNC5, via valve AV-11, and the downstream side of SNC5 is connected via valve AV-19 to the common exhaust pipe 21. The downstream side of the standard MFM5 is also connected, via valve AV-12, to the helium gas outlet 15. Standard MFM6 has the same downstream connection configuration, being connected to SNC6 via valve AV-13, and on the downstream side thereof is also connected to the common exhaust pipe 21 via valve AV-20. The downstream side of standard MFM6 passes through valve AV-14 and is connected to the helium gas outlet 15. The full-scale ranges of SNC5 and 6 are 2 SLM and 20 SLM.

The air inlet 13 is connected to solenoid valves SV-1 to SV-24, via valve MV-3 and regulator RG-3. The solenoid valves SV-1 to SV-24 are connected to corresponding air-operated valves AV-1 to AV-24, which are operated by the solenoid valves. The air inlet 13 is also connected to air outlet 16 via the regulator RG-4. The connection port 17 is connected to outlet 18 via valve AV-23, and to the nitrogen gas outlet 14 via valve AV-24.

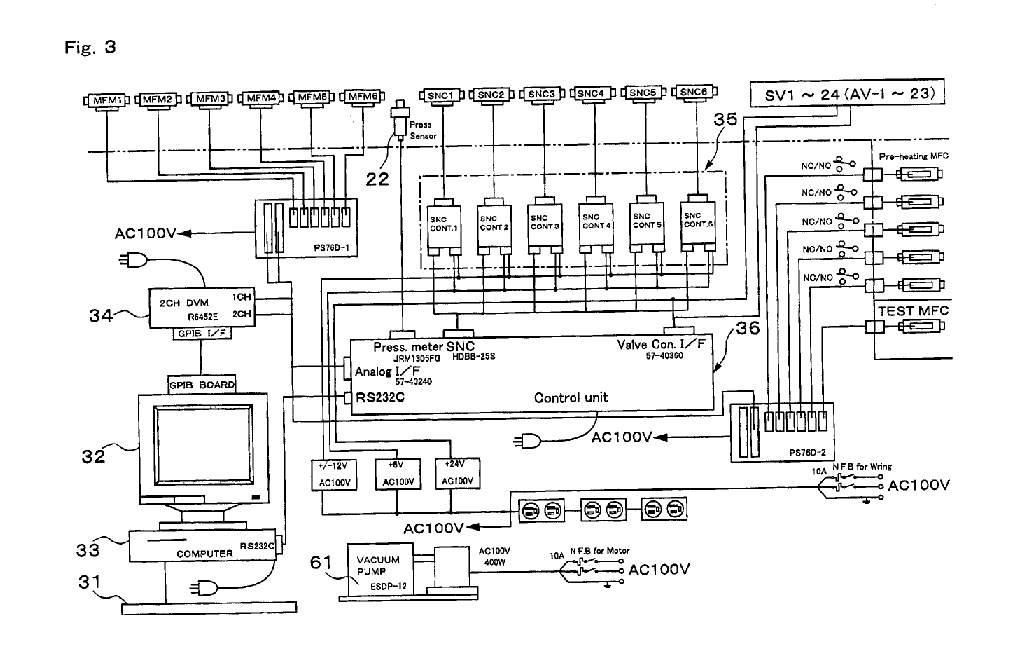

FIG. 3 is a schematic diagram of the electrical section 3. A microcomputer is the main component of the control unit 36. Based on the various parameters input from the desktop PC 33, the control unit 36 uses the solenoid valves SV-1 to SV-24 to work the valves AV-1 to AV-24 to select which gas lines and SNC are to be used, and performs the calibration of the target standard MFM During the calibration operation, based on the detection output of pressure sensor 22, the vacuum pump 61 is controlled to maintain a prescribed pressure differential between the upstream and downstream sides of the sonic nozzle of the SNC concerned. Based on instructions from the PC 33, the control unit 36 also carries out automatic measurements on the connected test MFC.

The operation of the heat type mass flowmeter calibration apparatus 1 will now be explained The software in the PC 33 includes a Std. MFM calibration program, a test program and a maintenance program. After starting the computer, the program to be used is selected from the starting screen. A parameter input screen appears before entering any of the program working screens, allowing the input of information required for the task. The Std. MFM calibration program is used to calibrate a Std. MFM using one or more of the SNC1 to 6. The test program is used to automatically perform various measurements on the test MFC. The maintenance program is used for maintenance and checking of the apparatus 1.

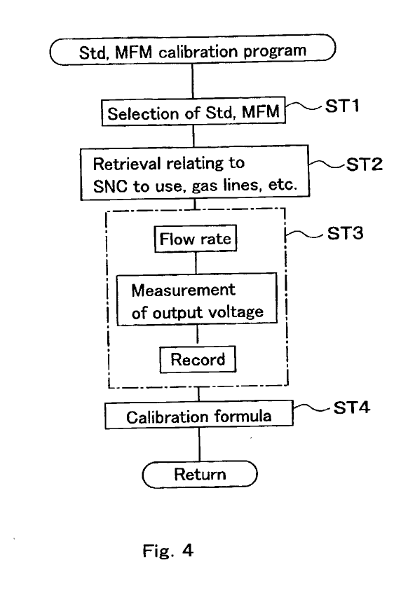

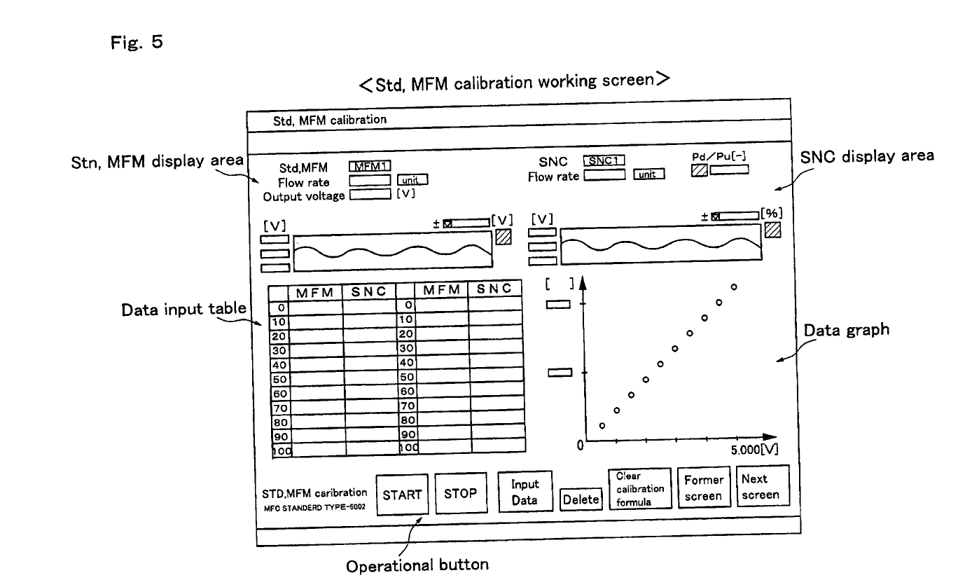

The calibration operation performed in accordance with the Std. MFM calibration program will now be explained, with reference to the flow chart of FIG. 4. The Std. MFM calibration program is selected on the start screen of the PC 33. The screen changes to the calibration parameter input screen, and the Std. MFM to be calibrated is selected from MFM1 to MFM6 (step ST1). Based on the MFM selected, conditions such as which SNC, gas lines and calibration gas to use, are automatically retrieved (step ST2). On completion of the automatic retrieval, the system switches to a working screen. FIG. 5 shows an example of the working screen. Display items include the Std. MFM to be calibrated, the number of the SNC used, flow rate, unit, output voltage, stability indicator, a graph of time-based changes in flow rate, pressure ratio, and so forth.

In this example, the SNC flow rate setting is changed in 10% increments and voltage output of the Std. MFM at each change is recorded on a data chart (step ST3). After selecting the SNC flow rate setting, the operator uses the graph of time-based change in flow rate, the stability indicator and so forth for data acquisition. After the output voltages of the Std. MFM have been measured, values are assigned to these voltages. Specifically, the following calibration formula is generated automatically on the calibration formula generation screen (step ST4).

Std. MFM flow rate=f(Std. MFM output voltage) with f(x)=aXⁿ+bX^{n·1}+ . . . +C(n=up to 4th order)

The calibration formula thus generated is stored in memory in the apparatus

1. During subsequent automatic measurements using the Std. MFM, calibration is performed using the output voltage of the Std. MFM substituted into the calibration formula. Automatic measurements are conducted on the test MFC on the basis of the calibrated values.

The operation of the test program will now be described. When the test program is selected on the start screen, the screen changes to the test program parameter input screen, which is used to input the test MFC data. Test program measurement items include zero point measurement of the test MFC, measurement of actual flow rate using a test MFC setting of 100%, measurement of actual flow rate at a test MFC setting of 50%, confirmation of test MFC control properties, and so forth.

While the foregoing embodiment uses six SNCs and MFMs, five or fewer, or seven or more, can be used. Also, calibration gases are not limited to the ones described in this example. Moreover, the test mass flowmeter does not have to be a heat type mass flowmeter, but can be other types of mass flowmeter.

As described in the foregoing, the mass flowmeter calibration apparatus according to the present invention includes a standard heat type mass flowmeter and sonic nozzle type mass flowmeter connected in series. Periodically or when required, the national-standard-traceable sonic nozzle type mass flowmeter is used to calibrate the standard heat type mass flowmeter, and actual flowmeter measurements are performed using the calibrated standard heat type mass flowmeter. Thus, in accordance with the present invention, even if the characteristics of the standard heat type mass flowmeter are changed by the passage of time, or by changes in ambient temperature, working pressure dependency or other such factors, measurement values obtained with the standard heat type mass flowmeter can be calibrated to within the degree of uncertainty of the sonic nozzle type mass flowmeter. This enables realization of a heat type mass flowmeter calibration apparatus that can always perform calibrations and measurements with good precision.

What is claimed is:

1. A flowmeter calibration apparatus comprising:
a reference standard heat type mass flowmeter that is used as a practical standard flowmeter for measurements of a test mass flowmeter;
a sonic nozzle type mass flow rate controller connected in series on a downstream side of the standard heat type mass flowmeter;
a connection port for effecting a series connection of the test mass flowmeter on the downstream side of the standard heat type mass flowmeter;
a vacuum pump for maintaining a prescribed ratio between upstream pressure and downstream pressure in the sonic nozzle type mass flow rate controller; and
a control section that includes reference standard flowmeter calibration means that uses the sonic nozzle type mass flow rate controller to effect calibration of the standard heat type mass flowmeter, and a test flow rate measurement means that, based on a result of said calibration, uses the standard heat type mass flowmeter to effect measurement of the test mass flowmeter connected to said connection port.

2. A flowmeter calibration apparatus according to claim 1, further comprising:
a gas delivery port;
n (where n is a positive integer) reference standard heat type mass flowmeters having different measurement ranges connected in series with the gas delivery port; and
said sonic nozzle type mass flow rate controllers having corresponding measurement ranges connected on the downstream side of the standard heat type mass flowmeters.

3. A flowmeter calibration apparatus according to claim 2, wherein said standard flowmeter calibration means includes selection means for selecting a standard heat type mass flowmeter to be calibrated; setting means for setting parameters, including calibration gas, of a sonic nozzle type mass flow rate controller used to calibrate the selected standard heat type mass flowmeter; recording means for incrementally changing flow rate settings of said sonic nozzle type mass flow rate controller and recording output voltage of the standard heat type mass flowmeter being calibrated; and calibration formula generation means that assigns flow rate values to recorded output voltages and generates a flow rate calibration formula for the standard heat type mass flowmeter.
